(19) United States
(12) Patent Application Publication
(10) Pub. No.: US 2026/0003768 A1
(43) Pub. Date: Jan. 1, 2026

(54) FUNCTIONAL SAFETY ANALYSIS USING DEBUGGING DATA

(71) Applicant: RED HAT, INC., Raleigh, NC (US)

(72) Inventors: Dennis Brendel, Grasbrunn (DE); Stephen Coady, Dublin (IE)

(21) Appl. No.: 18/757,795

(22) Filed: Jun. 28, 2024

(51) Int. Cl. G06F 11/36; G06F 8/61

(52) U.S. Cl. CPC G06F 11/3668; G06F 8/61; G06F 11/3624

(57) ABSTRACT

Function relations between or among functions in source code can be determined using debugging data. A service can receive a debugging file in a standardized format as input. The debugging file can correspond to compiled code generated subsequent to compiling the source code. The service can determine a set of functions based on the debugging file. The debugging file can include one or more attributes corresponding to the set of functions. Subsequently, the service can determine, based on the attributes, one or more function relations associated with the set of functions. The service then can generate a data structure mapping each function relation of the function relations to the source code. The service can automatically control deployment of the source code based on a compliance score that indicates compliance with a functional safety requirement. The compliance score can be generated based on the function relations indicated by the data structure.

### TECHNICAL FIELD

The present disclosure relates generally to software deployment and evaluation. More specifically, but not by way of limitation, this disclosure relates to functional safety analysis using debugging data.

### BACKGROUND

Software verification can involve analyzing a computer program with or without execution to determine calling relationships between callable units (e.g., subroutines or functions) in the computer program. Static program analysis involves analyzing computer programs without executing the computer programs. In contrast, dynamic program analysis is performed on computer programs during their execution in a computing environment. A control-flow graph, such as a call graph, can provide a visual representation of the calling relationships of the computer program. The control-flow graph can be used to identify functions that are not called or otherwise determine anomalies in the functions of the computer program.

Many organizations around the globe have developed functional safety standards for software and electronics. Functional safety relates to reducing risks so that computing systems function safely in the event that there is a malfunction. One example of a functional safety standard is ISO 26262 for automotive electronics. Functional safety standards can be used to avoid or mitigate systematic failures and hardware failures to prevent hazardous operational situations. A computer program or software package can be certified to a functional safety standard based on a target level of risk reduction that can be determined based on analyzing calling relationships of the computer program.

### BRIEF DESCRIPTION OF THE DRAWINGS

FIG. 1 is a block diagram of an example of a computing environment for functional safety analysis using debugging data according to some examples of the present disclosure.

FIG. 2 is a block diagram of an example of a debugging file that provides debugging data to determine one or more function relations according to some examples of the present disclosure.

FIG. 3 is a block diagram of another example of a computing environment for functional safety analysis using debugging data according to some examples of the present disclosure.

FIG. 4 is a flowchart of a process for functional safety analysis using debugging data according to some examples of the present disclosure.

### DETAILED DESCRIPTION

A software developer or software development organization may want or need to comply with a functional safety standard issued by a standard-setting organization when developing software for end users. Determining which code is invoked when calling specific functions can be used during functional safety analysis and certification. In some cases, analyzing the code can involve using source-based approaches in which source code is analyzed. But source-based approaches can be specific to particular programming languages and may have the source code undergo pre-processing prior to analysis. Pre-processing can cause errors, such as resulting in source code being selected during compiling such that incorrect code is erroneously analyzed. Additionally, source-based approaches can ignore macros and fail to derive dynamically decided indirect call targets.

Other approaches to analyzing the code can include register transfer language (RTL) approaches and binary approaches. RTL approaches can be specific to a compiler used to compile the code and may additionally be version-specific with respect to the compiler. RTL approaches may similarly lack functionality to detect macros and inlined code or derive dynamically decided indirect call targets. Binary approaches may be specific to a given instruction set architecture (ISA). A compiler used to compile source code may rearrange parts of the source code. Additionally, binary approaches can be similarly ineffective with respect to analyzing macros and inlined code. For instance, using a binary approach can cause inlined code to lose its relation to source code.

Some examples of the present disclosure can overcome one or more of the issues mentioned above by using debugging data to determine function relations, such as calling relationships. The debugging data can be provided in a standardized data format that is independent of a programming language of the source code, the ISA, the compiler, or a combination thereof. Additionally, the debugging data can include the full structure and relation (e.g., a 1:1 relationship) between compiled code and the source code. Accordingly, the debugging data can indicate a presence of inline functions or macros in the source code that may not be detectable in the compiled code using the aforementioned approaches. Additionally, the debugging data can provide information related to inputs or outputs of a particular function in the source code or the compiled code. Based on the information from the debugging data, candidate functions that may be called by the particular function can be determined, thereby deriving dynamically decided indirect call targets.

In one particular example, a service can receive a debugging file containing debugging data in a Debugging With Attributed Record Formats (DWARF) format. The debugging file can be generated by a compiler using source code. In particular, the compiler can generate a binary file that includes the debugging file stitched to an executable file, such as an executable file in an Executable and Linkable Format (ELF). Once the service receives the debugging file, the service can parse the debugging data to extract relevant information from the debugging data to determine function relations among functions of the source code. For instance, the service can extract one or more attributes corresponding to the functions of the source code. Statically available data extracted from the debugging data can be directly used to determine static relations and map the static relations to the source code. To determine dynamic relations, one or more rule sets or heuristics can be applied using the information extracted from the debugging data. After determining the static relations or the dynamic relations, the service can generate a data structure that includes or otherwise indicates the function relations. The data structure can be stored in a database accessible by other services (e.g., plugins), such as to perform functional safety analysis, debugging, or other suitable tasks.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

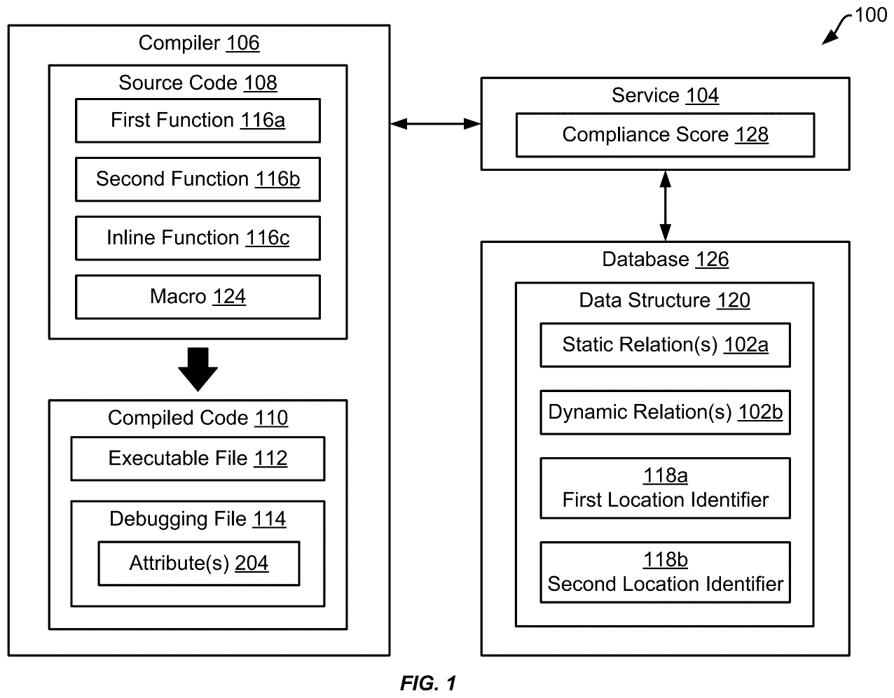

FIG. 1 is a block diagram of an example of a computing environment 100 for functional safety analysis using debugging data according to some examples of the present disclosure. In some cases, components within the computing environment 100 may be communicatively coupled via a network, such as a local area network (LAN), wide area network (WAN), the Internet, or any combination thereof. As shown, the computing environment 100 can include a service 104 and a compiler 106 that are communicatively coupled. In some implementations, the components of the computing environment 100 can be positioned in the same computing device. Examples of the computing device can include a desktop computer, laptop computer, server, mobile phone, or tablet. In other implementations, the components of the computing environment 100 may be positioned in separate computing devices or machines.

The compiler 106 can be a computer program that can translate source code 108 into compiled code 110 to create an executable file 112 and a debugging file 114 corresponding to the compiled code 110. As an example, the compiler 106 can generate a binary file in an Executable and Linkable Format (ELF) as the executable file 112. The debugging file 114 can have a standardized format that is applicable for various programming languages (e.g., C, C++, Rust, etc.). For example, the compiler 106 can generate a debugging file 114 in a Debugging With Attributed Record Formats (DWARF) format. Additionally, the debugging file 114 having a standardized format that is compatible with different types of compilers and different programming languages.

Compiling the source code 108 can involve translating computer code written in a source programming language into a different programming language (e.g., a target language). In particular, the compiler 106 can transform the computer code from a human-readable form into a binary form that a processor (e.g., a processing device) can execute. In some implementations, when a function 116 of the source code 108 is compiled, the function 116 can be translated into an associated function in the executable file 112. While the compiler 106 reads and parses the source code 108, the compiler 106 can collect information about the source code 108, such as respective location identifiers 118 corresponding to where an object (e.g., a variable, a data structure, a function 116, etc.) is declared or used. Semantic analysis can be applied to determine types of variables and arguments of the function(s) 116.

In some cases, prior to compiling the source code 108, the compiler 106 can perform pre-processing to modify text of the source code 108. For example, pre-processing can involve macro substitution, testing for conditional compilation directive, or file inclusion. When modifying the source code 108, pre-processing can cause errors resulting in incorrect code being included in the compiled code 110, thereby hindering an accurate assessment of the source code 108, such as with respect to functional safety. Additionally, compiling the source code 108 can involve rearranging the source code 108, which can make it difficult to map the compiled code 110 back to the source code 108. For example, optimizations can involve moving parts of the source code 108, combining similar blocks of code, expanding inline functions, or removing duplicate instructions or otherwise unnecessary components.

The service 104 can receive the debugging file 114 from the compiler 106 to use as an input. In some examples, the compiler 106 may transmit the debugging file 114 to the service 104 in response to a request from the service 104. Once the service 104 receives the debugging file 114, the service 104 can parse debugging data provided by the debugging file 114 to determine one or more function relations 102 between or among one or more functions 116 of the source code 108. Parsing the debugging data can involve analyzing the debugging data and building a data structure 120 based on the analysis of the debugging data. In some cases, the debugging file 114 is parsed offline such that the compiled code 110 is not executed. The debugging data in the debugging file 114 can undergo the same transformation process as the source code 108 that is used to generate the compiled code 110. Accordingly, the debugging data can contain sufficient or suitable information to relate parts of the executable file 112 to the source code 108. Although the service 104 is generally described herein as determining function relations for functions, it will be appreciated that the service 104 can determine relations among or between other callable units (e.g., subprograms, procedures, subroutines, etc.) in addition to or instead of for functions.

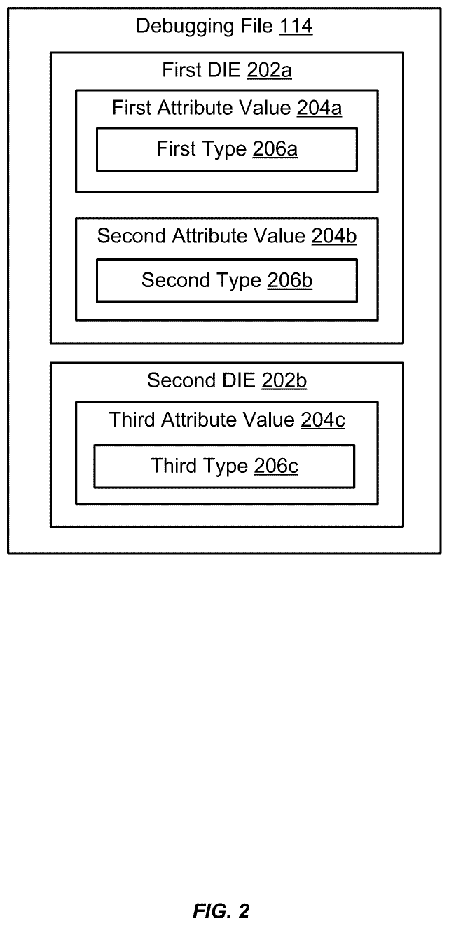

In some examples, the debugging file 114 can be structured using one or more debugging information entries (DIEs). A particular DIE or a group of DIEs can provide a description of a corresponding entity in the source code 108. In some cases, the debugging file 114 can include a line table or another suitable data structure that can map executable instructions (e.g., the executable file 112) to the source code 108 used to generate the executable instructions. FIG. 2 is a block diagram of an example of a debugging file 114 that provides debugging data to determine one or more function relations 102 according to some examples of the present disclosure. As shown in FIG. 2, the debugging file 114 can include a first DIE 202a and a second DIE 202b. The DIEs 202a-b can describe data types, variables, functions, or executable code blocks. Each DIE 202 can include a tag that can function as an identifier for the DIE 202 and can specify what the DIE 202 describes, such as by specifying a class to which the DIE 202 belongs.

Additionally, each DIE 202 can include one or more attributes 204 that can further describe the DIE 202 by defining specific characteristics of the DIE 202. For example, the attributes 204 can provide information related to the functions 116 of the source code 108, such as a respective location in the source code 108 or function arguments. The attributes 204 can also be referred to as attribute values. In some implementations, each attribute in a particular DIE can have a unique attribute type that is not shared by other attributes of the particular DIE. The attributes 204 can include a variety of values. For example, the attributes 204 may be constants (e.g., a function name), variables (e.g., a start address of a function 116), references to a different DIE (e.g., a type of a return value for a particular function), or a combination thereof.

As shown in FIG. 2, the first DIE 202a can have a first attribute value 204a corresponding to a first attribute type 206a and a second attribute value 204b corresponding to a second attribute type 206b that is different from the first attribute type 206a. As an example, the first attribute type 206a can correspond to a file location of the source code 108 containing an inline function call, while the second attribute type 206b can correspond to a line number of an inline function call. In other words, the first attribute value 204a can function as a file indicator (e.g., using an integer) with respect to the file in which an inline function 116c is called. As shown in FIG. 1, the inline function 116c can be a third function defined in the source code 108. The inline function 116c can be a function that the compiler 106 copies code from a function definition directly into code of a corresponding calling function rather than generating a separate set of instruction in memory. In other words, a copy of the function definition or function body may be directly substituted to perform the inline function call. Similarly, the second attribute value 204b can indicate a specific line of the file in which the inline function 116c is called. Accordingly, an inline function call associated with the inline function 116c defined by the attribute values 204a-b can be mapped to the source code 108. In particular, the attribute values 204a-b can define a call site of the inline function 116c.

The second DIE 202b can have a third attribute value 204c corresponding to the first attribute type 206a. In some cases, the first attribute value 204a can be different from the third attribute value 204c while sharing the first attribute type 206a. As an example, if the third attribute value 204c is associated with the first attribute type 206a, the third attribute value 204c may indicate a different file of the source code 108 that includes a different inline function call. In other cases, as shown, the third attribute value 204c can have a third attribute type 2060 that is different from the first attribute type 206a and the second attribute type 206b. For example, the third attribute type 206c can correspond to macro preprocessor information, which can be used to identify or describe a macro call in the source code 108. In some examples, the third attribute value 204c can be used to determine information related to a location of a macro 124 called in the source code 108. In particular, a line number or a file of the source code 108 that includes the macro 124 can be determined using a macro information entry provided in the debugging file 114. Additionally or alternatively, the debugging file 114 may include values of the macro 124 or suitable information to translate the macro 124 into a corresponding source language.

Returning to FIG. 1, the service 104 can extract relevant information from the debugging file 114 to identify a set of functions (e.g., the functions 116a-c). In some examples, the service 104 may use certain identifiers of the source code to identify the functions. For example, the service 104 can use a request identifier to identify application programming interfaces (APIs), interrupt request handlers, exception handlers, etc. In other examples, the service 104 can use the attributes 204 of the debugging file 114 to identify the functions 116 that are defined in the source code 108 or the compiled code 110. As described with respect to FIG. 2, the service 104 can determine that an inline function 116c is present in the source code 108 based on the attributes 204 provided in the debugging file 114. Similarly, the service 104 can determine that a macro 124 is called by a particular function in the source code 108 based on the attributes 204 extracted from the debugging file 114.

Once the functions 116 have been identified, the service 104 can determine one or more function relations 102 (e.g., calling relationships, dependencies, etc.) of the functions 116, such as by using characteristics defined by the attributes 204 of the debugging file 114. In some implementations, the service 104 may assess each individual function and parse what types of information are encoded with respect to each function. The service 104 then can identify a pair of functions or a group of functions associated with each other. In particular, the service 104 can determine which other functions a particular function being assessed can call and can determine function arguments corresponding to the called functions. The called functions can also be referred to herein as call targets. In some examples, the service 104 may use a known function as an entry point into the source code 108. For example, the service 104 can have existing information associated with the known function prior to reading or parsing the debugging file 114. In some cases, the existing information may be provided by a user to the service 104, such as using an input device (e.g., a keyboard, mouse, touchscreen, etc.). The service 104 can start with the known function when determining the function relations 102, such as by determining which other functions may be called by the known function and for what reasons. In other words, the known function can be a starting point for the service 104 to determine the function relations 102 of the source code 108.

In some examples, the service 104 can obtain statically available information from the debugging file 114. Examples of the statically available information can include symbols, such as function names, variable names, variables of global scope or static scope, etc. In general, symbols can correspond to a string of characters. Based on the statically available information, the service 104 can determine one or more static relations 102a. An example of the static relations 102a can be direct function calls. The static relations 102a can correspond to unchanging associations (e.g., direct function calls, shared objects, etc.) or dependencies between or among a subset of the functions 120a defined in the source code 108.

In some examples, the service 104 can identify a function signature provided as part of the attributes 204 of the debugging file 114. The function signature can define one or more function arguments of a particular function (e.g., one or more inputs, one or more outputs, or a combination thereof). Based on a respective function signature of each function, the service 104 can determine calling relationships of the functions 116, such as whether a particular function is a calling function, a call target (e.g., a called function), or a combination thereof. In some implementations, the service 104 can use the function signature(s) or other suitable attributes provided in the debugging file 114 to identify a pair of functions or a group of functions associated with each other. For example, a calling function characterized by a static relation can have a fixed address (e.g., known at compile time) as a function argument such that the same call target is called by the calling function at run time. In other words, if a first function 116a is a calling function with a static relation with respect to a second function 116b, the first function 116a can be configured to have an unchanging calling relationship with the second function 116b. Accordingly, the service 104 can determine that a calling relationship exists between a call target that is called by the calling function based on the function signature provided in the debugging file 114.

Additionally or alternatively, the service 104 can obtain dynamic data from the debugging file 114. In some examples, dynamic data can correspond to data that can be variable at run time, whereas static data (e.g., the statically available information) can be fixed and determined at compile time. The service 104 can use the dynamic data to determine one or more dynamic relations 102b. In some implementations, the dynamic relations 102b can correspond to a variable association between or among a subset of the functions 116 defined in the source code 108. An example of the dynamic relations 102b can be indirect function calls. In some cases, a function pointer can be included in the source code 108 to provide a mechanism to call a specific function chosen at run time, thereby generating an indirect function call. The function pointer can be a symbolic representation of an address, enabling indirect function calls by call-by-reference or by generating or modifying dynamic data structures.

In contrast to the static relations 102a described above, a calling function that has dynamic relations 102b can be associated with multiple call targets such that calling relationships of the calling function are variable. In particular, the called function that is called by the calling function may change for different code executions. The call target may be unknown at compile time. Determining the dynamic relations 102b can involve one or more rule sets, heuristics, or a combination thereof. For example, the rule sets and/or heuristics can be used to determine one or more candidate functions that can be possible call targets of a calling function. The candidate functions can be functions defined in the source code, such as the first function 116a or the second function 116b. In some implementations, one or more call targets may be selected from the candidate functions as called functions corresponding to the calling function.

In some examples, the rule sets and/or heuristics can involve determining inputs of the calling function, thereby determining criteria by which to filter the functions 116 of the source code to determine the candidate functions. For example, the service 104 can determine one or more function arguments of the first function 116a based on the attributes 204 provided in the debugging file 114. Based on the function arguments, the service 104 can identify one or more candidate functions (e.g., the second function 116b or the inline function 116c) of the source code 108 that can be called by the first function 116a. As another example, the service 104 can determine that the calling function can use a register to determine a function argument, which can indicate that the calling function can perform an indirect function call. Specifically, each calling function or each called function can be associated with one or more registers that can store register values, such as function arguments or pointers, and can be used to pass certain function arguments to the functions 116. In some instances, contents of the register at a specific point in a control flow may determine a called target of the calling function. The service 104 can use the register to narrow down the candidate functions associated with the calling function. In particular, the called function can be selected from the candidate functions associated with the register at run time. In some cases, the called function can be selected based on a value loaded in the register before the indirect function call is made. As yet another example, the service 104 can use a function signature of the first function 116a provided in the debugging file 114 to determine that the first function 116a takes two integers as function arguments. The service 104 then can search a list of symbols or other statically available information to match with the first function 116a that take two integers as input.

In some implementations, the service 104 can determine at least part of the dynamic relations 102b using one or more composite location descriptions that can specify a respective location of the functions 116 or other suitable objects. Examples of the composite location descriptions can be location expressions, location lists, or a combination thereof. The location expressions can depend on values in certain registers. The rule sets or the heuristics used to determine the dynamic relations 102b can be generated at least in part based on the composite location descriptions. In particular, the composite location descriptions can function as criteria by which to filter the functions 116 of the source code 108 to determine the candidate functions. For example, if the composite location description is a location expression, the location expression can include a sequence of operations indicating how to locate a particular object or another entity. Specifically, the location expression can indicate whether the particular object is located in a register, in memory, or a combination thereof. In other words, the location expression can indicate and describe data that has been split up and stored in different locations, such as where some data is stored in memory and other data is stored in registers.

In some cases, a respective location list corresponding to each object of the source code 108 can describe various locations of the object over the object's lifetime. In particular, the location lists can describe certain objects that have a limited lifetime or change their location during their lifetime. The location lists can be provided as part of the location expressions. Each location list can have one or more entries that can describe a corresponding location of the object. Each entry can include a starting value and an ending value to indicate an address range of a particular object.

Once the service 104 determines the function relations 102 of the functions 116, the service 104 can map the function relations 102 to the source code 108. In some implementations, the service 104 may also map the symbols to the source code 108. In some examples, mapping the function relations 102 or the symbols to the source code may involve determining a corresponding location with respect to the source code 108. In some examples in which the function relations 102 correspond to calling relationships, the service 104 can determine a respective location identifier 118 based on the attributes 204 provided by the debugging file 114. Each location identifier 118 can be associated with a corresponding called function of each calling relationship. For example, a first location identifier 118a and a second location identifier 118b can correspond to a respective function (e.g., the first function 116a and the second function 116b) of the source code 108. Additionally, each location identifier can indicate a respective location of the corresponding called function in the source code. In some cases, the location identifier 118 can correspond to a respective line number, a respective column number, or a respective file of the source code 108. As another example, if the first function 116a and the second function 116b reference the same global object, the service 104 can generate a mapping with respect to the source code 108 to indicate that the functions 116a-b are associated with a shared global object. The mapping can represent a relationship between the functions 116a-b and can indicate that the shared global object is referenced at one or more particular locations in the source code 108.

In some examples, after mapping the function relations 102 to the source code 108, the service 104 can generate a data structure 120 that indicates each mapping of the function relations 102. For example, the service 104 may generate a table as the data structure 120 that can include separate columns to indicate calling functions and a respective location of their call targets in the source code 108. As another example, the service 104 may generate a call graph or another suitable control-flow graph that graphically represents calling relationships or other suitable relations between or among the functions 116. In some implementations, the call graph can provide a visual representation (e.g., via a user interface) of how the functions 116 in the source code 108 or the executable file 112 relate to or interact with each other.

Additionally or alternatively, the service 104 can store the data structure 120 representing the function relations 102 in a database 126 or another suitable storage system. Once stored in the database 126, the data structure 120 can be accessible by other software or programs (e.g., tools, services, plugins, etc.). For example, the service 104 may include an additional layer that provides debugging functionalities. The additional layer of the service 104 may access the data structure 120 to facilitate bug detection or vulnerability detection with respect to the source code 108. Additionally, the additional layer may enable a user to set breakpoints to step through the source code 108 while debugging. Setting the breakpoints can involve specifying a line number or a function name, which can be determining using the data structure 120. In some cases, the service 104 can enable coordination between the compiler 106 and a separate debugging tool in the computing environment 100 by generating and providing access to the data structure 120. As another example, a code editor may use the data structure 120 to provide a click point to the source code 108. In particular, a graphical interface provided by the code editor may include a link or another suitable click point that can be selected by a user to direct the user to a particular location in the source code 108. As yet another example, a scoring engine in the computing environment 100 may use the data structure 120 to determine a compliance score 128 that can indicate compliance of the source code 108 with respect to a safety standard.

In some implementations, the data structure 120 can be used in functional safety analysis. Functional safety can relate to reducing risks so that software functions safely if an electrical malfunction or an electronic malfunction occurs. Software can be certified to a functional safety standard based on a particular safety classification that defines a target level of risk reduction. For example, an Automotive Safety Integrity Level (ASIL) can be determined for software used in automotive applications (e.g., cars or other suitable vehicles). In some implementations, the data structure 120 can be used to determine a compliance score 128 of the source code 108 or the compiled code 110 with respect to a functional safety requirement. The functional safety requirement can be part of a safety standard set by a standard-setting organization, such as the International Organization for Standardization (ISO).

In some examples, the compliance score 128 generated based on the data structure 120 can be used to control deployment of the source code 108 based on whether the source code 108 is compliant with the functional safety requirement. For example, if the compliance score 128 of the source code 108 is below a predefined threshold associated with the functional safety requirement, the source code 108 may be deemed noncompliant with the functional safety requirement and vice versa. Based on the source code 108 being noncompliant with the functional safety requirement, the service 104 or another suitable component of the computing environment 100 may prevent the source code 108 from being deployed. In some cases, such as if the compliance score 128 is below the predefined threshold, the data structure 120 can be used to identify certain functions or blocks of code with dependencies that can contribute to cascading failures or cross-communication. Based on the blocks of code that are identified, a developer can update or modify the source code 108 to reduce a risk of software malfunction. Additionally, by updating the source code 108, the developer can enable the source code 108 to be deployed by increasing the compliance score 128 to exceed the predefined threshold.

While FIGS. 1-2 depicts a specific arrangement of components, other examples can include more components, fewer components, different components, or a different arrangement of the components shown in FIGS. 1-2. For instance, in other examples, a debugging file 114 may include one DIE or more than two DIEs. Additionally, any component or combination of components depicted in FIGS. 1-2 can be used to implement the process(es) described herein.

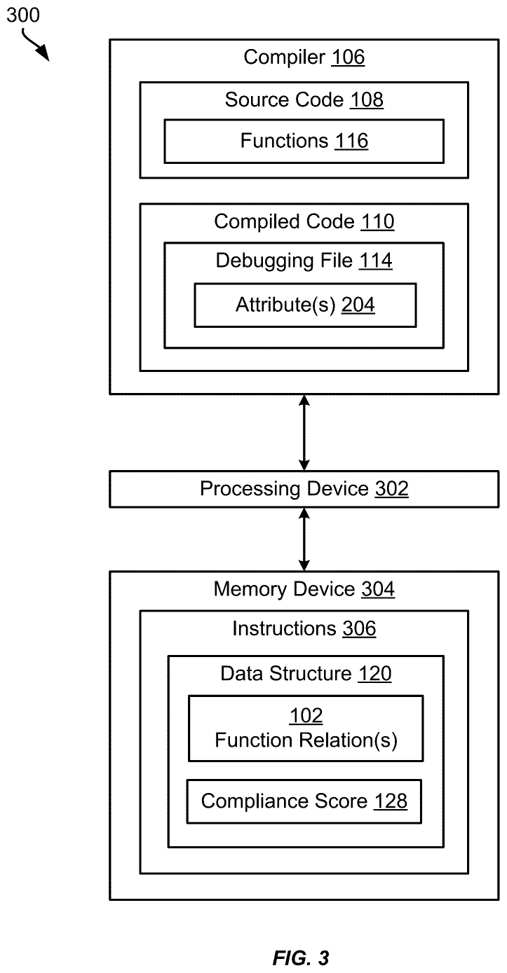

FIG. 3 is a block diagram of another example of a computing environment 300 for functional safety analysis using debugging data according to some examples of the present disclosure. The computing environment 300 can include a processing device 302 communicatively coupled to a memory device 304. Certain aspects of FIG. 3 are described with respect to components of FIGS. 1-2.

The processing device 302 can include one processing device or multiple processing devices. The processing device 302 can be referred to as a processor. Non-limiting examples of the processing device 302 include a Field-Programmable Gate Array (FPGA), an application-specific integrated circuit (ASIC), and a microprocessor. The processing device 302 can execute instructions 306 stored in the memory device 304 to perform operations. In some examples, the instructions 306 can include processor-specific instructions generated by a compiler or an interpreter from code written in any suitable computer-programming language, such as C, C++, C#, Java, Python, or any combination of these.

The memory device 304 can include one memory device or multiple memory devices. The memory device 304 can be non-volatile and may include any type of memory device that retains stored information when powered off. Non-limiting examples of the memory device 304 include electrically erasable and programmable read-only memory (EEPROM), flash memory, or any other type of non-volatile memory. At least some of the memory device 304 includes a non-transitory computer-readable medium from which the processing device 302 can read instructions 306. A computer-readable medium can include electronic, optical, magnetic, or other storage devices capable of providing the processing device 302 with the instructions 306 or other program code. Non-limiting examples of a computer-readable medium include magnetic disk(s), memory chip(s), ROM, random-access memory (RAM), an ASIC, a configured processor, and optical storage.

In some examples, the processing device 302 can use debugging data from a debugging file 114 to determine function relations 102 (e.g., calling relationships, dependencies, shared objects, etc.). The processing device 302 can receive the debugging file 114 generated by a compiler 106 based on source code 108. In some cases, the debugging file 114 can be in a standardized format and can indicate structure and relations between compiled code 110 and the source code 108. In particular, the debugging file 114 can relate the compiled code 110 with the source code 108. After receiving the debugging file 114, the processing device 302 can determine a set of functions 116 of the source code 108 based on one or more attributes 204 indicated in the debugging file 114. For example, the processing device 302 can use the attributes 204 to determine a programming language of the source code 108. The processing device 302 then can apply a rule set specific to the programming language of the source code 108 to identify the functions 116 or parts of the functions 116 (e.g., a declaration) in the source code 108. In some cases, the rule set can be used to identify one or more predefined functions associated with the programming language.

Subsequent to determining the functions 116, the processing device 302 can determine one or more function relations 102 based on the attributes 204 provided in the debugging file 114. For example, the processing device 302 can use the attributes 204 to determine a calling function and a called function of the functions 116 in the source code 108. Additionally, the attributes 204 can indicate a line number, a column number, a file identifier, or other suitable information describing a respective location of the calling function and the called function in the source code 108. Accordingly, the processing device 302 can generate one or more mappings to represent the function relations 102 determined using the attributes 204. In some examples, the processing device 302 may generate a data structure 120 mapping each function relation of the function relations 102 to the source code 108. For example, the processing device 302 can output a graphical user interface to display a call graph as the data structure 120 to visually represent the function relations 102.

Additionally, the processing device 302 can automatically control deployment of the source code 108 based on a compliance score 128 determined using the mappings of the function relations 102. For example, the processing device 302 can prevent or delay deployment of the source code 108 based on the compliance score 128 being below a predefined threshold that can be associated with a safety requirement for the source code 108. On the other hand, if the compliance score 128 is at or above the predefined threshold, the processing device 302 may allow the source code 108 to be deployed, such as in a software package.

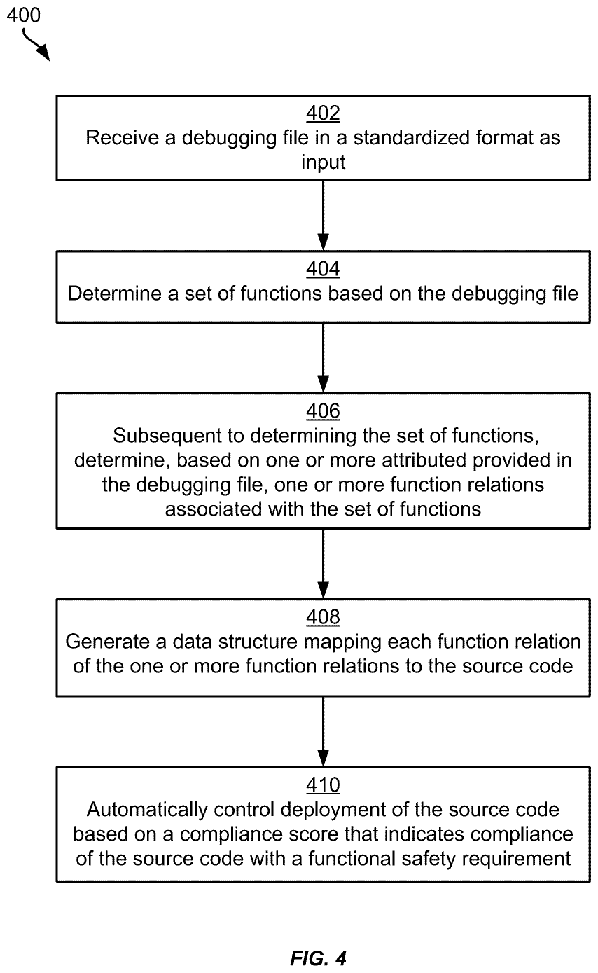

FIG. 4 is a flowchart of a process 400 for functional safety analysis using debugging data according to some examples of the present disclosure. In some examples, the processing device 302 can perform one or more of the steps shown in FIG. 4. In other examples, the processing device 302 can implement more steps, fewer steps, different steps, or a different order of the steps depicted in FIG. 4. The steps of FIG. 4 are described below with reference to components discussed above in FIGS. 1-3.

In block 402, the processing device 302 receives a debugging file 114 in a standardized format as input. The debugging file 114 can correspond to compiled code 110 generated by a compiler 106 subsequent to compiling source code 108. In some examples, the processing device 302 may receive the debugging file 114 as part of a binary file generated by the compiler 106 in response to compiling the source code 108. The debugging file 114 being in a standardized format can result in the debugging file 114 being language-independent and compiler-independent. For example, the debugging file 114 may be generated by different compilers that are compatible with different programming languages. In some examples, the debugging file 114 can be generated as part of a binary file, such as being coupled to an executable file 112 of the binary file.

In block 404, the processing device 302 determines a set of functions 116 based on the debugging file 114. The debugging file 114 can include one or more attributes 204 corresponding to the functions 116. In some examples, the debugging file 114 can be structured to include one or more information entries that include a respective set of attributes. The attributes 204 can describe specific characteristics associated with the functions 116. For example, the processing device 302 can use the attributes 204 to determine that the source code 108 includes an inline function 116c and where to locate the inline function 116c in the source code 108. Similarly, the debugging file 114 can include information that the processing device 302 can use to identify a macro 124 and relate the macro 124 back to the source code 108.

In block 406, subsequent to determining the set of functions 116, the processing device 302 determines the function relations 102 associated with the functions 116 based on the attributes 204 provided in the debugging file 114. The attributes 204 can describe various aspects of the source code 108, the compiled code 110, or a combination thereof. In some examples, each attribute 204 can be associated with a corresponding attribute type 206. For example, the processing device 302 can extract an attribute value 204 corresponding to an attribute type 206 that can describe a call site corresponding to a call target of a calling function. In some cases, for direct function calls, the processing device 302 can determine that the attribute value 204 of an information entry can provide a reference to another information entry that describes the call target. In other cases, for indirect function calls, the processing device 302 can use the attribute value 204 as a reference to data representing a pointer (e.g., a function pointer) that is called. For instance, the attribute value 204 may include a location expression. If the call target is unknown at compile time, the processing device 302 can use the location expression to determine a corresponding address of the call target that will be called.

In block 408, the processing device 302 generates a data structure 120 mapping each function relation of the one or more function relations 102 to the source code 108. For example, the processing device 302 can create a table that represents each function relation and describes a respective location of each function relation with respect to the source code. In particular, the respective location of each function relation can be indicated using a line number, a column number, or a file identifier associated with the source code 108. As another example, the processing device 302 can generate a call graph that provides a graphical representation of the function relations 102. After generating the data structure 120, the processing device 302 may store the data structure 120 in a database 126 such that the data structure 120 can be accessible by other services, tools, etc.

In block 410, the processing device 302 automatically controls deployment of the source code 108 based on a compliance score 128 that indicates compliance of the source code 108 with a functional safety requirement. The compliance score 128 can be a numeric value (e.g., decimal, integer, percentage, etc.) that can correspond to a level of compliance of the source code 108 with respect to the functional safety requirement. For example, a higher compliance score can suggest a higher level of compliance and lower risk of failures compared to a lower compliance score. In some cases, the compliance score 128 can be generated based on the one or more function relations 102 indicated by the data structure 120. For example, the service 104 or another suitable component of a computing environment (e.g., the computing environment 100 of FIG. 1) can include a scoring engine configured to generate the compliance score 128. The scoring engine can apply a set of rules to the data structure 120 to determine the compliance score 128 for the source code 108. In some examples, the set of rules may be predefined or customizable by a user.

Based on the compliance score 128, the processing device 302 can determine whether to deploy the source code 108, such as to an entity. In some examples, the processing device 302 can use a predefined threshold to determine whether to deploy the source code 108 or to prevent the source code 108 from being deployed. For example, the predefined threshold can correspond to a minimum level of compliance with the functional safety requirement. If the compliance score 128 is above the predefined threshold, the processing device 302 may deploy the source code 108 or otherwise authorize deployment of the source code 108. On the other hand, if the compliance score 128 is below the predefined threshold, the processing device 302 can prevent the source code 108 from being deployed indefinitely or until an updated compliance score of the source code 108 is above the predefined threshold. In some examples, the processing device 302 may output a notification to a user to indicate that the compliance score 128 is below the predefined threshold. In response to the notification, the user may apply one or more modifications to the source code 108 to improve (e.g., increase) the compliance score 128 of the source code 108 such that the compliance score 128 exceeds the predefined threshold.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving a debugging file in a standardized format as input, the debugging file corresponding to compiled code generated by a compiler subsequent to compiling source code;
determining a set of functions based on the debugging file, the debugging file including one or more attributes corresponding to the set of functions;
subsequent to determining the set of functions, determining, based on the one or more attributes provided in the debugging file, one or more function relations associated with the set of functions;
generating a data structure mapping each function relation of the one or more function relations to the source code; and
automatically controlling deployment of the source code based on a compliance score that indicates compliance of the source code with a functional safety requirement, the compliance score generated based on the one or more function relations indicated by the data structure.

2. The system of claim 1, wherein determining the one or more function relations further comprises determining, using the one or more attributes provided by the debugging file, at least one static relation, and wherein the at least one static relation corresponds to an unchanging association between a subset of the functions.

3. The system of claim 1, wherein determining the one or more function relations further comprises determining, using the one or more attributes provided by the debugging file, at least one dynamic relation, and wherein the at least one dynamic relation corresponds to a variable association between a subset of the functions.

4. The system of claim 1, wherein determining the one or more function relations further comprises:
extracting, using the debugging file, the one or more attributes used to define the set of functions; and
determining, based on the one or more attributes, that the source code comprises a macro call, wherein the macro call indicates that a macro of the source code is called by a particular function of the set of functions.

5. The system of claim 1, wherein determining the one or more function relations further comprises:
extracting, using the debugging file, the one or more attributes used to define the set of functions; and
determining, based on the one or more attributes, that the source code comprises an inline function call, wherein the inline function call indicates that an inline function of the source code is called by a particular function of the set of functions.

6. The system of claim 1, wherein mapping each function relation of the one or more function relations to the source code comprises:
identifying, based on the one or more function relations, one or more called functions called by a respective function of the set of functions; and
determining, based on the one or more attributes of the debugging file, a respective location identifier associated with each called function of the one or more called functions, wherein each location identifier corresponds to a respective location of a respective called function in the source code.

7. The system of claim 1, wherein determining the one or more function relations further comprises, for a particular function of the set of functions:
determining that the particular function is a calling function based on a function signature of the particular function, wherein the function signature is provided as part of the one or more attributes of the debugging file and indicates a calling relationship between the calling function and a call target; and
identifying, based on the function signature, the call target configured to be called by the particular function.

8. A method comprising:
receiving, by a processing device, a debugging file in a standardized format as input, the debugging file corresponding to compiled code generated by a compiler subsequent to compiling source code;
determining, by the processing device, a set of functions based on the debugging file, the debugging file including one or more attributes corresponding to the set of functions;
subsequent to determining the set of functions, determining, by the processing device based on the one or more attributes provided in the debugging file, one or more function relations associated with the set of functions;
generating, by the processing device, a data structure mapping each function relation of the one or more function relations to the source code; and
automatically controlling deployment of the source code based on a compliance score that indicates compliance of the source code with a functional safety requirement, the compliance score generated based on the one or more function relations indicated by the data structure.

9. The method of claim 8, wherein determining the one or more function relations further comprises determining, using the one or more attributes provided by the debugging file, at least one static relation, and wherein the at least one static relation corresponds to an unchanging association between a subset of the functions.

10. The method of claim 8, wherein determining the one or more function relations further comprises determining, using the one or more attributes provided by the debugging file, at least one dynamic relation, and wherein the at least one dynamic relation corresponds to a variable association between a subset of the functions.

11. The method of claim 8, wherein determining the one or more function relations further comprises:
extracting, using the debugging file, the one or more attributes used to define the set of functions; and
determining, based on the one or more attributes, that the source code comprises a macro call, wherein the macro call indicates that a macro of the source code is called by a particular function of the set of functions.

12. The method of claim 8, wherein determining the one or more function relations further comprises:
extracting, using the debugging file, the one or more attributes used to define the set of functions; and
determining, based on the one or more attributes, that the source code comprises an inline function call, wherein the inline function call indicates that an inline function of the source code is called by a particular function of the set of functions.

13. The method of claim 8, wherein mapping each function relation of the one or more function relations to the source code comprises:
identifying, based on the one or more function relations, one or more called functions called by a respective function of the set of functions; and
determining, based on the one or more attributes of the debugging file, a respective location identifier associated with each called function of the one or more called functions, wherein each location identifier corresponds to a respective location of a respective called function in the source code.

14. The method of claim 8, wherein determining the one or more function relations further comprises, for a particular function of the set of functions:
determining that the particular function is a calling function based on a function signature of the particular function, wherein the function signature is provided as part of the one or more attributes of the debugging file and indicates a calling relationship between the calling function and a call target; and
identifying, based on the function signature, the call target configured to be called by the particular function.

15. A non-transitory computer-readable medium comprising program code executable by a processing device for causing the processing device to perform operations comprising:
receiving a debugging file in a standardized format as input, the debugging file corresponding to compiled code generated by a compiler subsequent to compiling source code;
determining a set of functions based on the debugging file, the debugging file including one or more attributes corresponding to the set of functions;
subsequent to determining the set of functions, determining, based on the one or more attributes provided in the debugging file, one or more function relations associated with the set of functions;
generating a data structure mapping each function relation of the one or more function relations to the source code; and
automatically controlling deployment of the source code based on a compliance score that indicates compliance of the source code with a functional safety requirement, the compliance score generated based on the one or more function relations indicated by the data structure.

16. The non-transitory computer-readable medium of claim 15, wherein determining the one or more function relations further comprises determining, using the one or more attributes provided by the debugging file, at least one static relation, and wherein the at least one static relation corresponds to an unchanging association between a subset of the functions.

17. The non-transitory computer-readable medium of claim 15, wherein determining the one or more function relations further comprises determining, using the one or more attributes provided by the debugging file, at least one dynamic relation, and wherein the at least one dynamic relation corresponds to a variable association between a subset of the functions.

18. The non-transitory computer-readable medium of claim 15, wherein determining the one or more function relations further comprises:
extracting, using the debugging file, the one or more attributes used to define the set of functions; and
determining, based on the one or more attributes, that the source code comprises a macro call, wherein the macro call indicates that a macro of the source code is called by a particular function of the set of functions.

19. The non-transitory computer-readable medium of claim 15, wherein determining the one or more function relations further comprises:
extracting, using the debugging file, the one or more attributes used to define the set of functions; and
determining, based on the one or more attributes, that the source code comprises an inline function call, wherein the inline function call indicates that an inline function of the source code is called by a particular function of the set of functions.

20. The non-transitory computer-readable medium of claim 15, wherein mapping each function relation of the one or more function relations to the source code comprises:
identifying, based on the one or more function relations, one or more called functions called by a respective function of the set of functions; and
determining, based on the one or more attributes of the debugging file, a respective location identifier associated with each called function of the one or more called functions, wherein each location identifier indicates a respective location of each called function in the source code.
